(19) United States
(12) Patent Application Publication
(10) Pub. No.: US 2025/0367728 A1
(43) Pub. Date: Dec. 4, 2025

(54) PLATELET NANOPARTICLES, COMPOSITIONS THEREOF, AND FORMATION THEREOF

(71) Applicant: Kuprion Inc., Waterbury, CT (US)

(72) Inventors: Randall M. Stoltenberg, American Fork, UT (US); Alfred A. Zinn, San Jose, CA (US); Maria Palen, Pacifica, CA (US); Romel Lakandula, Milpitas, CA (US); Aaron Seno, Sunnyvale, CA (US)

(21) Appl. No.: 18/875,432

(22) PCT Filed: Jun. 22, 2023
(86) PCT No.: PCT/US2023/025938

§ 371 Date: Dec. 16, 2024

Related U.S. Application Data
(60) Provisional application No. 63/355,415, filed on Jun. 24, 2022.

(51) Int. Cl. B22F 1/054; B22F 1/102; B23K 35/02; B23K 35/30; B23K 35/36; C23C 24/06

(52) U.S. Cl. CPC B22F 1/0551; B22F 1/102; B23K 35/025; B23K 35/302; B23K 35/3612; C23C 24/06; B22F 2301/10; B22F 2304/054

(57) ABSTRACT

Metal nanoparticles may be grown under conditions that promote formation of platelet nanoparticles having a surfactant coating thereon. Such conditions may include slow metal salt reduction and slow cooling following metal nanoparticle formation. The platelet nanoparticles have a fusion temperature significantly below the melting point of the corresponding bulk metal and form robust structures upon undergoing consolidation with one another. Compositions may comprise a plurality of metal nanoparticles having a surfactant coating thereon, in which at least about 20% of the metal nanoparticles are platelet nanoparticles and the surfactant coating comprises at least one surfactant. The compositions may further comprise varying amounts of substantially spherical metal nanoparticles. The metal nanoparticles may be formulated into nanoparticle paste compositions, sprayable formulations, and inks that may aid in dispensation and consolidation of the metal nanoparticles.

### BACKGROUND

Although lead has traditionally been used in numerous industrial applications, current regulations have mandated the elimination and/or phase out of lead in most commercial products. Soldering applications, particularly in electronics and vehicle manufacturing, have been heavily impacted by the ban on lead. Numerous alternatives to traditional lead-based solders have been developed, the Sn/Ag/Cu (SAC) system being among the most widely used, but many have exhibited drawbacks that can make them unsuitable for use in certain applications, such as excessive expense (each added wt. % of silver roughly doubles cost, and tin is expensive as well), high eutectic melting points, and potential whisker growth for tin-based solders containing high percentages of tin.

Compositions containing metal nanoparticles are beginning to be used as alternatives to traditional soldering materials. Such compositions are increasingly being referred to as sintered metal systems. Metal nanoparticles that are about 100 nm or less in size, particularly those that are about 20 nm or less in size, can exhibit an apparent melting point depression over that of the corresponding bulk metal, thereby allowing the metal nanoparticles to be pseudo-liquefied and consolidated at temperatures that are comparable to traditional soldering materials. Spherical copper nanoparticles, for example, have been extensively studied as an alternative soldering material due to the high thermal and electrical conductivity of this metal, as well as the benefit of copper's relatively low cost. Once metal consolidation has taken place at or above the fusion temperature, the melting point of the resulting metal matrix reverts to a value close to that of the corresponding bulk metal, thereby allowing suitable operating conditions for consolidated metal nanoparticles to be based upon the melting point of the bulk metal, instead of the much lower fusion temperature of the metal nanoparticles.

Numerous processes for producing substantially spherical metal nanoparticles in a targeted size range with a narrow particle size distribution have been developed, typically by utilizing a surfactant to control nucleation and growth rates of the metal nanoparticles. Although compositions containing substantially spherical metal nanoparticles can be suitable for many applications, considerable care may need to be exercised to produce a robust metal matrix upon consolidation, particularly when the metal matrix needs to carry a mechanical load or is subject to mechanical stress, for instance. Without being bound by theory or mechanism, the void volume in close-packed or near close-packed metal spheres may lead to excessive porosity when producing a bulk metal matrix upon consolidating substantially spherical metal nanoparticles. The void volume may further result from a gradual rigidizing of the metal matrix as metal nanoparticle consolidation takes place to form a bulk metal state. Thus, the looser the initial packing state of the metal nanoparticles, the higher the porosity of the resulting bulk metal state. Use of substantially spherical metal nanoparticles having a bimodal particle size distribution may address this difficulty to some degree by facilitating a higher packing density prior to the metal nanoparticles undergoing consolidation with one another.

In addition to soldering applications, metal nanoparticles have been proposed for use in a number of other fields including, but not limited to, communications, electronics, and medical uses. Silver nanoparticles and gold nanoparticles have been used extensively for these purposes. Effective consolidation of substantially spherical metal nanoparticles remains challenging within these fields and many others as well. For example, silver nanoparticles may require up to one hour of heating to promote effective consolidation, and pressure may need to be applied to achieve an acceptable density, electrical conductivity, and thermal conductivity in the resulting bulk metal. For high-temperature applications in an electric field, migration of silver may be problematic. In addition, high material costs for precious metal systems remains challenging as well. Gold nanoparticles, for instance, are prohibitively expensive for most applications.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one having ordinary skill in the art and having the benefit of this disclosure.

FIGS. 1 and 2 are diagrams of presumed structures of substantially spherical metal nanoparticles having a surfactant coating thereon.

FIG. 3 is a diagram of the presumed structure of a platelet nanoparticle having a surfactant coating thereon.

FIG. 4 is a diagram showing substantially spherical metal nanoparticles in a close packing configuration.

FIG. 5 is a diagram showing platelet nanoparticles in an overlapping, stacked packing configuration.

FIG. 6 is a diagram showing how platelet nanoparticles may undergo stacking and consolidation with one another.

FIG. 7 is a histogram of the particle size distribution obtained from a representative copper nanoparticle synthesis in which platelet nanoparticles are produced.

FIGS. 8A-8D are illustrative SEM images of copper nanoparticles produced at various rates of reducing agent introduction.

FIG. 9 is an illustrative SEM image of a bulk copper matrix formed upon sintering copper nanoparticles that are predominantly platelet nanoparticles.

FIGS. 10A-10C are illustrative photographs of thin films formed from copper nanoparticles of various types following sintering.

### DETAILED DESCRIPTION

The present disclosure is generally directed to metal nanoparticles and, more specifically, metal nanoparticle compositions containing platelet nanoparticles and formation and use thereof.

As discussed above, substantially spherical metal nanoparticles, such as copper nanoparticles, may be consolidated to form a bulk metal matrix. However, considerable care may need to be exercised in order to form a robust bulk metal matrix when consolidating substantially spherical copper nanoparticles, including application of pressure to achieve a suitable density in some cases.

The present disclosure provides compositions comprising metal nanoparticles in which at least a portion of the metal nanoparticles are platelet nanoparticles (i.e., metal nanoparticles having a plate-like morphology rather than being substantially spherical in shape). At least about 20% of the metal nanoparticles in the compositions, and oftentimes more, may comprise platelet nanoparticles in the compositions described herein. Surprisingly, several concurrent modifications of the synthetic conditions used to produce substantially spherical metal nanoparticles may instead afford compositions containing significant amounts of platelet nanoparticles, as discussed further herein. Whereas substantially spherical metal nanoparticles may result from rapid introduction (e.g., 1-2 minute addition time) of a reducing agent to a solution containing a metal salt and one or more surfactants, slower addition of the reducing agent to the solution and maintaining the reaction medium at a controlled temperature, sometimes without applying additional heat thereto, may afford at least partial formation of platelet nanoparticles. Slow cooling of the reaction medium may further aid in promoting formation of platelet nanoparticles. The platelet nanoparticles may be formed in combination with substantially spherical metal nanoparticles in various instances, wherein the platelet nanoparticles may be present in a larger or smaller amount than the substantially spherical metal nanoparticles, depending on synthesis conditions. The ratio between substantially spherical metal nanoparticles and platelet nanoparticles may be further tailored through regulation of additional components present within the reaction medium in which metal nanoparticle formation takes place. For example, the types and amounts of surfactants within the organic solvent in which metal nanoparticle formation takes place may further influence the type(s) of metal nanoparticles that are formed.

There is a natural limitation of how densely spheres can be packed in three-dimensional space. For single-size spheres, theory predicts that an ideal cubic close packed or hexagonal close packed structure is filled about 74% efficiently by volume (26% void volume). When packing metal nanoparticles having two different sizes with about a 10:1 diameter ratio of larger relative to smaller metal nanoparticles, the packing density can increase to about 87% (13% void volume). Random packing arrangements afford considerably more void volume (approximately 36%), which is frequently the arrangement found when depositing metal nanoparticles upon a surface. As a result of these features, it can be problematic to form robust bulk metal matrices from substantially spherical metal nanoparticles.

Compositions comprising platelet nanoparticles, preferably containing platelet nanoparticles as at least a majority of the metal nanoparticles with the compositions, may afford much more robust bulk metal matrices upon undergoing metal nanoparticle consolidation. Greater than 90% packing efficiencies may be realized (less than 10% void volume) to produce much denser metal matrices (e.g., within thin films, solder-like joints, injected molded parts, and the like) than are possible when consolidating substantially spherical metal nanoparticles alone. The packing efficiency may further increase upon aging, thermal shock, and/or thermal cycling. Without being bound by theory or mechanism, the platelet nanoparticles are believed to afford much denser packing prior to metal nanoparticle consolidation, the denser packing being facilitated by layer-on-layer stacking of the platelets, thereby leading to a less porous (more dense) bulk metal matrix following consolidation. As such, a higher degree of long-range integrity may be realized in bulk metal matrices resulting from metal nanoparticle consolidation. These benefits may be realized even when consolidation takes place with little to no application of external pressure, in contrast to the behavior of substantially spherical metal nanoparticles. Electrical conductivity values achieved upon consolidating metal nanoparticles containing significant quantities of platelet nanoparticles may approach that of bulk metal structures produced by techniques such as casting or plating, for instance. At the very least, the electrical conductivity achieved upon consolidating platelet nanoparticles may exceed that of bulk metal structures produced upon consolidating substantially spherical metal nanoparticles alone.

In addition to the benefits afforded by the platelet nanoparticles themselves, compositions containing significant quantities of platelet nanoparticles may be formulated as nanoparticle pastes that may further promote ready consolidation of the metal nanoparticles as dense bulk metal matrices, as well as facilitate ready dispensation of the metal nanoparticles. Sprayable formulations and inks comprising the platelet nanoparticles also may be prepared and provide similar benefits. In addition, as solvents and other volatiles are removed from compositions containing platelet nanoparticles, the platelet nanoparticles may be further drawn together as the platelet nanoparticles undergo consolidation, thereby increasing the packing efficiency still further.

Once metal nanoparticles have been processed into a bulk metal matrix, the bulk metal matrix may remain stable up to a temperature approaching the melting point of the corresponding bulk metal. Accordingly, metal nanoparticles and nanoparticle pastes containing metal nanoparticles may allow initial processing to take place at relatively low temperatures (˜180-240° C. or below, depending on the metal, the size of the metal nanoparticles, and the ratio of platelet nanoparticles to substantially spherical metal nanoparticles) and then facilitate use at much higher operating temperatures. The low initial processing conditions are advantageously compatible with a range of substrate materials and processing conditions used for forming integrated circuits and other electronic materials, which may constitute one non-limiting type of application for the metal nanoparticles described herein. Such processing conditions may be similar to those used in traditional soldering applications.

Copper may be a desirable metal for forming metal nanoparticles, such as metal nanoparticles containing significant amounts of platelet nanoparticles, as described herein, due to the low cost and high electrical and thermal conductivity value of this metal. Additional disclosure regarding copper nanoparticles and syntheses thereof is provided hereinafter.

Before discussing the embodiments of the present disclosure in further detail, a brief description of metal nanoparticles and metal nanoparticle pastes will first be provided, with copper nanoparticles being a representative example of such metal nanoparticles, so that the remaining disclosure may be better understood. Metal nanoparticles exhibit a number of properties that can differ significantly from those of the corresponding bulk metal. One property of metal nanoparticles that can be of particular importance is nanoparticle fusion or consolidation that occurs at the metal nanoparticles' fusion temperature. As used herein, the term “fusion temperature” refers to the temperature at which a metal nanoparticle appears to liquefy, thereby giving the appearance of melting. As used herein, the terms “fusion” and “consolidation” synonymously refer to the coalescence or partial coalescence of metal nanoparticles with one another at or above the fusion temperature to form a larger mass (sintered mass) of a bulk metal matrix, such as a bulk copper matrix. The bulk metal matrix may take on various forms such as a thin film, an electrical or thermal connection between two surfaces, an interconnect, a solder joint, or a larger bulk metal block. The morphology of the bulk metal matrix may be influenced by the quantity of platelet nanoparticles present in combination with substantially spherical metal nanoparticles, as described in further detail herein.

Upon decreasing in size, particularly below about 20 nm in equivalent spherical diameter in the case of substantially spherical metal nanoparticles, the temperature at which metal nanoparticles appear to liquefy drops dramatically from that of the corresponding bulk metal. For example, substantially spherical copper nanoparticles within a suitable size range can have fusion temperatures of about 240° C. or below, or about 220° C. or below, or about 200° C. or below, in comparison to bulk copper's melting point of 1084° C. Both substantially spherical metal nanoparticles and platelet nanoparticles may exhibit decreased fusion temperatures of this type. For example, platelet nanoparticles comprising copper and having particle sizes as described herein may exhibit a fusion temperature of about 180° C. to about 240° C., or about 200° C. to about 240° C., or about 220° C. to about 240° C., which may differ only slightly from that of substantially spherical metal nanoparticles. Without being bound by theory, it is believed that platelet nanoparticles may exhibit low fusion temperatures at larger particle sizes than do substantially spherical metal nanoparticles as a consequence of the lower thermodynamic stability of platelet nanoparticles, as discussed further below. Upon consolidation of metal nanoparticles at or above the fusion temperature, a bulk metal matrix may be fabricated at significantly lower processing temperatures than when working directly with the bulk metal itself as a starting material. Once the bulk metal matrix has been formed from metal nanoparticles, the melting point approaches that of the bulk metal itself, and the bulk metal matrix contains a plurality of grain boundaries.

Platelet nanoparticles have a higher surface area relative to comparable-sized spherical nanoparticles, thereby providing higher contact between other platelet nanoparticles for promoting consolidation into a bulk metal matrix. Advantageously, platelet nanoparticles of the present disclosure may lead to decreased formation of such grain boundaries within the bulk metal matrix. The decreased formation of grain boundaries may translate to improved electrical and thermal performance once the platelet nanoparticles have been consolidated together. The decreased formation of grain boundaries may result from the tendency of stacked platelet nanoparticles to merge into larger crystalline phases, rather than multiple points of contact occurring in the case of substantially spherical metal nanoparticles to produce a great number of grain boundaries. The tendency of platelet nanoparticles to merge into larger crystalline phases is believed to arise from the atomically flat surface of the platelet nanoparticles, and the ready alignment of the crystal lattices therein as the platelet nanoparticles stack upon one another. Substantially spherical metal nanoparticles, in contrast, may undergo an energetically unfavorable rearrangement to form a polycrystalline phase with multiple grain boundaries. The platelet nanoparticles may be considered atomically flat when at least a portion of their upper or lower surfaces appears substantially planar when viewed in an SEM image, for instance. In some cases, the thickness of the platelet nanoparticles may vary in a stair-step fashion, with individual sections of the platelet nanoparticles being atomically flat before transitioning abruptly to another atomically flat section. That is, the platelet nanoparticles may have different through-plane thicknesses at various locations thereon in some cases.

Another aspect related to the atomically flat surfaces of the platelet nanoparticles is their higher reactivity compared to comparably sized metal nanoparticles that are substantially spherical in shape. Without being bound by theory or mechanism, the higher reactivity is believed to result from a lower thermodynamic stability of the platelet nanoparticles in comparison to substantially spherical metal nanoparticles. As such, platelet nanoparticles may display characteristic metal nanoparticle properties (e.g., low fusion temperature) above a particle size threshold at which these properties begin to disappear in substantially spherical metal nanoparticles.

Although the relatively high reactivity of platelet nanoparticles may be desirable in many instances, the lower thermodynamic stability of platelet nanoparticles makes their production in preference to substantially spherical metal nanoparticles rather difficult. The present disclosure overcomes this challenge to afford compositions containing significant amounts of platelet nanoparticles.

As used herein, the term “metal nanoparticle” refers to metal particles that are about 150 nm or less in size in one or more dimensions, particularly about 100 nm or less in size in one or more dimensions. In substantially spherical metal nanoparticles, the foregoing values may represent a diameter of the sphere, whereas in platelet nanoparticles the foregoing may represent a lateral dimension or a through-plane dimension (longitudinal thickness) of the metal nanoparticles. Platelet nanoparticles of the present disclosure may have a lateral dimension up to about 400 nm in some cases, while still being classified as nanoparticles by virtue of having a longitudinal thickness of about 150 nm or less. As used herein, the term “copper nanoparticle” refers to a metal nanoparticle made from copper or predominantly copper.

As used herein, the term “micron-scale metal particles” refers to metal particles that are larger than metal nanoparticles and range up to about 1000 μm in size, such as about 1 μm to about 1000 μm in size, or about 5 μm to about 500 μm in size. Micron-scale metal particles may be substantially spherical in shape or have a non-spherical shape, such as dendritic or rod-like.

The terms “consolidate,” “consolidation” and other variants thereof are used interchangeably herein with the terms “fuse,” “fusion” and other variants thereof.

As used herein, the terms “partially fused,” “partial fusion,” and other derivatives and grammatical equivalents thereof refer to the partial coalescence of metal nanoparticles with one another. Whereas totally fused metal nanoparticles may retain little of the structural morphology of the original, unfused metal nanoparticles (i.e., they resemble bulk metal with minimal grain boundaries), partially fused metal nanoparticles retain at least some of the structural morphology of the original unfused metal nanoparticles. The properties of partially fused metal nanoparticles can be intermediate between those of the corresponding bulk metal and the original unfused metal nanoparticles.

A number of scalable processes for producing bulk quantities of metal nanoparticles in a targeted size range have been developed, preferably producing substantially spherical metal nanoparticles in the targeted size range. Particularly facile metal nanoparticle fabrication techniques for producing substantially spherical metal nanoparticles and uses thereof are described in, for example, U.S. Pat. Nos. 7,736,414, 8,105,414, 8,192,866, 8,486,305, 8,834,747, 9,005,483, 9,095,898, 9,700,940, 9,797,032, 9,881,895, and 9,976,042, each of which is incorporated herein by reference in its entirety. Such processes for producing substantially spherical metal nanoparticles take place by reducing a metal precursor (metal salt) in a solution and in the presence of a surfactant system containing one or more surfactants. Platelet nanoparticles may be synthesized through similar processes by modifying various reaction conditions as described further herein. Without being bound by any theory or mechanism, it is believed that the surfactant system can mediate the nucleation and growth of the metal nanoparticles, limit surface oxidation of the metal nanoparticles, and/or inhibit metal nanoparticles from extensively aggregating with one another prior to being at least partially fused together. The metal nanoparticles can then be isolated and purified from the reaction mixture by common isolation techniques and processed into a nanoparticle paste, if desired.

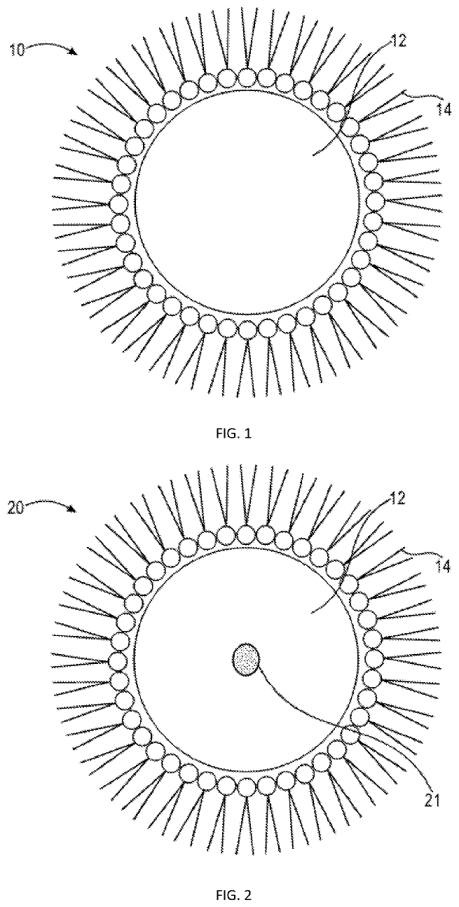

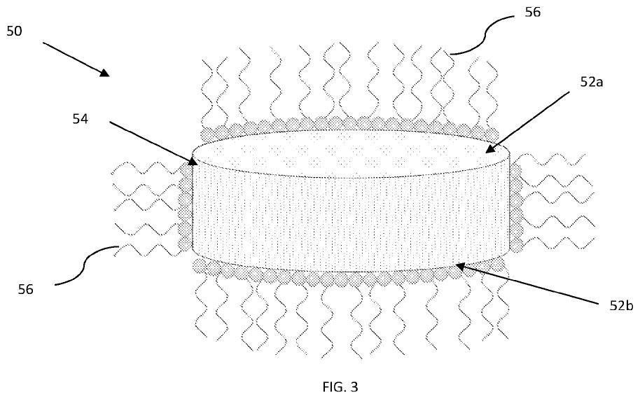

FIGS. 1 and 2 are diagrams of presumed structures of substantially spherical metal nanoparticles having a surfactant coating thereon. Although shown for round or spherical metal nanoparticles in FIGS. 1 and 2, the concepts shown therein are applicable to platelet nanoparticles having other geometric shapes. As shown in FIG. 1, metal nanoparticle 10 includes metallic core 12 and surfactant layer 14 overcoating metallic core 12. Surfactant layer 14 can contain any combination of surfactants, as described in more detail below. Metal nanoparticle 20, shown in FIG. 2, is similar to that depicted in FIG. 1, except metallic core 12 is grown about nucleus 21, which can be a metal that is the same as or different than that of metallic core 12. Because nucleus 21 is buried deep within metallic core 12 in metal nanoparticle 20, it is not believed to significantly affect the overall nanoparticle properties. FIG. 3 is a diagram of the presumed structure of platelet nanoparticle 50 having surfactant layer 54 thereon. Although depicted as disc-shaped in FIG. 3, other geometric shapes are possible, as discussed further below. Platelet nanoparticle 50 includes substantially planar faces 52a and 52b, which may be atomically flat in most cases, and longitudinal face(s) 54 extending between substantially planar faces 52a and 52b. Substantially planar faces 52a and 52b may be substantially parallel to one another. Surfactant layer 56 overcoats substantially planar faces 52a and 52b, and longitudinal face(s) 54. Different surfactants may be present upon substantially planar faces 52a and 52b and longitudinal face(s) 54 in some cases.

The metal nanoparticles may be single crystalline, polycrystalline, and/or amorphous. Platelet nanoparticles and substantially spherical metal nanoparticles, even if co-produced during a given metal nanoparticle synthesis, may have differing morphologies from one another. For example, platelet nanoparticles may be single-crystalline and have no or limited grain boundaries once consolidated, whereas substantially spherical metal nanoparticles may be amorphous or polycrystalline and exhibit multiple grain boundaries once consolidated. Substantially spherical metal nanoparticles having a size of about 10 nm or less may be significantly more amorphous in character due to the energetic unfavorability of maintaining a crystalline phase at this particle size range.

Without being bound by theory or mechanism, the difference in crystallinity is believed to arise from the mechanisms through which substantially spherical metal nanoparticles and platelet nanoparticles form and grow. Specifically, substantially spherical metal nanoparticles are believed to grow through Ostwald ripening, whereas platelet nanoparticles do not. The Ostwald ripening leads to consolidation of multiple small particles in the substantially spherical metal nanoparticles, thereby leading to polycrystallinity. The single-crystallinity of platelet nanoparticles may lead to alignment of their crystal lattices during stacking, thereby promoting consolidation and formation of minimal, low-energy grain boundaries.

Further without being bound by theory or mechanism, the growth of platelet nanoparticles is believed to occur under kinetic growth conditions, whereas substantially spherical metal nanoparticles may form under thermodynamic growth conditions by virtue of their higher thermodynamic stability. Specifically, if nanoparticle growth can be slowed sufficiently, such that kinetic growth conditions begin to take effect, platelet nanoparticles may be effectively formed. Factors influencing kinetic versus thermodynamic growth conditions may include, for example, temperature, growth time, type(s) and amount(s) of surfactant(s) used, and the like.

Kinetic versus thermodynamic metal nanoparticle growth are believed to influence how and where surfactants attach to a growing metal nanoparticle. Amorphous spherical nanoparticles may be initially formed because of their greater thermodynamic stability, thereby avoiding lone corner or edge atoms that are needed to produce a crystalline particle. As the nanoparticles start to grow larger, a crystalline structure may become more stable. Once specific crystal planes begin developing, surfactants with a specific geometry or shape may preferentially adhere to certain crystal planes more so than other planes, thereby further favoring formation of the crystalline phase. Thus, if kinetic growth conditions can be induced by slowing down the nanoparticle formation process (e.g., via control of temperature, speed of reduction and cool down), the growth morphology may be altered to favor production of platelet nanoparticles having a crystalline phase. The chosen surfactant(s) and their concentration may further aid this process. Specified surfactant(s) may attach preferentially to a particular crystalline face and block growth in one direction in favor of another direction.

A further advantage of slowing down the growth rate in accordance with the foregoing is that higher metal salt concentrations may be utilized without affecting product quality, including the size and size distribution of the platelet nanoparticles that are produced. The increased metal salt concentration may facilitate increased production yields per run. In the case of producing platelet nanoparticles, metal salt concentrations ranging from about 20% to about 60% higher than in comparable syntheses affording substantially spherical metal nanoparticles may be utilized, for example.

Suitable metal salts for producing metal nanoparticles may include those that are soluble in the chosen organic solvent. Non-limiting examples of suitable metal salt include, but are not limited to, metal halides, metal carboxylates, metal nitrates, and the like. For example, anhydrous copper chloride may be utilized for forming copper nanoparticles, including platelet nanoparticles, in the disclosure herein.

Suitable organic solvents for solubilizing metal salts and forming metal nanoparticles may include, for example, formamide, N,N-dimethylformamide, dimethyl sulfoxide, dimethylpropylene urea, hexamethylphosphoramide, tetrahydrofuran, glyme, diglyme, triglyme, and tetraglyme. The concentration of the metal salt in the chosen organic solvent may vary over a wide range and be dictated by the solubility properties of the metal salt, for example. Reducing agents suitable for reducing metal salts and promoting the formation of metal nanoparticles may include, for example, an alkali metal in the presence of a suitable catalyst (e.g., lithium naphthalide, sodium naphthalide, or potassium naphthalide) or borohydride reducing agents (e.g., sodium borohydride, lithium borohydride, potassium borohydride, or tetraalkylammonium borohydrides).

The reaction temperature used for producing metal nanoparticles, including platelet nanoparticles, may range from room temperature (25° C.) or even below, up to about 40° C., or up to about 50° C., or up to about 55° C., or up to about 60° C., or up to about 65° C., or up to about 70° C. The foregoing temperatures represent the maximum temperature the reaction is allowed to reach during formation of the metal nanoparticles. The maximum temperature may be regulated by an addition rate of the reducing agent, as discussed subsequently. The reaction medium may be heated externally while adding the reducing agent and/or the reducing agent may be heated, provided that the maximum temperature of the reaction remains below the foregoing values. In some instances, no external heating is applied to a reaction medium from which platelet nanoparticles are formed, and a temperature rise in the reaction medium may result from exothermicity of the metal salt reduction by the reducing agent.

The addition rate of the reducing agent to a solution containing the metal salt may impact the extent to which exothermic heating during reduction raises the temperature of the reaction medium. Surprisingly, a suitably slow addition rate may further promote formation of platelet nanoparticles as well. To aid in maintaining the temperature of the reaction medium below a maximum temperature of about 50° C., or about 55° C., or about 60° C., or up to about 65° C., or up to about 70° C., the addition rate of the reducing agent may be maintained at a slow rate to limit the extent to which exothermic heating overheats the reaction mixture and decreases production of platelet nanoparticles. In non-limiting examples, the reducing agent may be added to a solution containing a metal salt and a suitable surfactant system such that the reducing agent is completely combined over about 5 minutes or more, or about 6 minutes or more, or about 7 minutes or more, or about 8 minutes or more, or about 9 minutes or more, or about 10 minutes or more, or about 15 minutes or more, or about 20 minutes or more, or about 25 minutes or more, or about 30 minutes or more, or about 40 minutes or more, or about 50 minutes or more, or about 1 hour or more, or about 2 hours or more, as well as any closed sub-range within any of the foregoing values. For instance, in non-limiting examples, the reducing agent may be added to the solution containing the metal salt over about 5 minutes to about 30 minutes, or about 10 minutes to about 40 minutes, or about 6 minutes to about 15 minutes, or about 8 minutes to about 20 minutes, or about 10 minutes to about 25 minutes, or about 12 minutes to about 24 minutes, or about 16 minutes to about 32 minutes, or about 18 minutes to about 36 minutes.

The addition rate of the reducing agent may be selected to afford a maximum temperature increase of the reaction medium within a desired range. In non-limiting examples, the addition rate of the reducing agent may be selected to promote a temperature increase of at most about 30° C., or at most about 25° C., or at most about 20° C., or at most about 15° C., or at most about 10° C., or at most about 5° C. As non-limiting examples, the reducing agent may be added to a room temperature solution of the metal salt at a rate sufficient to promote a temperature increase of at most about 20° C. or at most about 25° C. and a maximum temperature of about 45° C., or the reducing agent may be added to a 30° C. solution of the metal salt at a rate sufficient to promote a temperature increase of at most about 10° C. and a maximum temperature of about 40° C. In still other examples, the reducing agent may be added to a solution of the metal salt having a temperature of at most about 35° C., about 45° C., or about 55° C. to afford a temperature increase of at most about 5° C., or the reducing agent may be added to a solution of the metal salt having a temperature of at most about 25° C., about 35° C., or about 45° C. to afford a temperature increase of at most about 10° C. or a temperature increase of at most about 15° C., or the reducing agent may be added to a solution of the metal salt having a temperature of at most about 20° C., about 30° C., or about 40° C. to afford a temperature increase of at most about 20° C. In still other instances, it may be desirable to add the reducing agent to the solution containing the metal salt with the solution maintained at a temperature below room temperature, such as at a temperature ranging from about −10° C. to about 15° C., or about 0° C. to 15° C.

In still other non-limiting examples, the reducing agent may be added to the solution of the metal salt at a rate sufficient to maintain the solution at a temperature ranging from about 30° C. to about 70° C., or about 30° C. to about 65° C., or about 30° C. to about 60° C., or about 40° C. to about 70° C., or about 40° C. to about 60° C., or about 50° C. to about 70° C., or about 50° C. to about 60° C., or about 35° C. to about 50° C., or about 35° C. to about 60° C., or about 35° C. to about 70° C., or about 40° C. to about 70° C., or about 40° C. to about 60° C., or about 45° C. to about 70° C., or about 45° C. to about 60° C. while forming the metal nanoparticles, at least a portion of which comprise platelet nanoparticles and preferably at least about 20% of which comprise platelet nanoparticles.

Once metal nanoparticles have formed upon addition of the reducing agent, the reaction medium may be held at temperature for a desired period of time or be allowed to cool to a lower temperature, such as room temperature, at which isolation of the nanoparticles may take place. In non-limiting examples, the reaction medium may be cooled from the heating temperature to room temperature over about 30 minutes, or over about 1 hour, or over about 2 hours, or over about 3 hours, or over about 4 hours, or over about 6 hours, or over about 10 hours. Slow cooling may likewise promote formation of platelet nanoparticles.

As discussed above, the surfactant system present upon the surface of the metal nanoparticles can include one or more surfactants. The differing properties of various surfactants may be used to tailor the properties of the metal nanoparticles. Factors that may be taken into account when selecting a surfactant or combination of surfactants for inclusion upon the metal nanoparticles include, for example, ease of surfactant dissipation from the metal nanoparticles during or before nanoparticle fusion, nucleation and growth rates of the metal nanoparticles, the metal component of the metal nanoparticles, and the like. Formation of a surfactant coating upon metal nanoparticles during their syntheses can desirably limit the ability of the metal nanoparticles to fuse to one another before heating above the fusion temperature, limit agglomeration of the metal nanoparticles, and promote the formation of a population of metal nanoparticles having a narrow size distribution. The surfactant coating contains at least one surfactant that was present during formation of the metal nanoparticles. When more than one type of surfactant is used during formation of the metal nanoparticles, each type of surfactant or less than each type of surfactant may become located in the surfactant coating. Again, the particular surfactants that become incorporated as a surfactant coating upon the platelet nanoparticles may depend upon the specific surfactant(s) used and their ability to coordinate to particular faces of the platelet nanoparticles. The surfactant coating is generally lost during consolidation of the metal nanoparticles upon heating above the fusion temperature, although at least some surfactant loss may occur below the fusion temperature for lower-boiling surfactants and how strongly they are bound to the metal nanoparticles. In various embodiments, the surfactant coating may be non-polymeric in nature.

In some embodiments, an amine surfactant or combination of amine surfactants, particularly aliphatic amines, can be present upon the metal nanoparticles. Amine surfactants can be particularly desirable for use in conjunction with copper nanoparticles or metal nanoparticles containing alternative transition metals, for example. In some embodiments, two amine surfactants can be used in combination with one another. In other embodiments, three amine surfactants can be used in combination with one another. Four amine surfactants may also be used in combination with one another in some instances. In more specific embodiments, a primary amine, a secondary amine, and a diamine may be used in combination with one another when forming the metal nanoparticles. In still more specific embodiments, the three amine surfactants can include a long chain primary amine having a straight-chain or branched alkyl group, a secondary amine having a straight-chain or branched alkyl group, and a diamine having at least one tertiary alkyl group substituent upon the nitrogen atom(s). Accordingly, at least some, including one, more than one, or all, of the at least one amine surfactant may comprise a branched alkyl chain. Further disclosure regarding suitable amine surfactants follows hereinafter.

In some embodiments, the surfactant system can include a primary alkylamine. In some embodiments, the primary alkylamine can be a C₂-C₁₈ alkylamine, wherein the alkyl group can be straight-chain or branched. In some embodiments, the primary alkylamine can be a C₆-C₁₀ alkylamine, wherein the alkyl group can be straight-chain or branched. In some embodiments, a C₅-C₆ primary alkylamine can be used, wherein the alkyl group can be straight-chain or branched. Without being bound by any theory or mechanism, the exact size of the primary alkylamine can be balanced between being long enough to provide an effective inverse micelle structure during synthesis of the metal nanoparticles versus having ready volatility and/or ease of handling during nanoparticle consolidation. For example, primary alkylamines with more than 18 carbons can also be suitable for use in the present disclosure, but they can be more difficult to handle because of their waxy character. C₆-C₁₀ primary alkylamines, in particular, can represent a good balance of desired properties for ease of use.

Suitable C₂-C₁₈ primary alkylamines can include n-hexylamine, n-heptylamine, n-octylamine, n-nonylamine, or n-decylamine, for example. While these are all straight-chain primary alkylamines, branched chain primary alkylamines can also be used in other embodiments. For example, branched chain primary alkylamines such as, for example, 7-methyloctylamine, 2-methyloctylamine, or 7-methylnonylamine can be used. In some embodiments, such branched chain primary alkylamines can be sterically hindered where they are attached to the amine nitrogen atom. Non-limiting examples of such sterically hindered primary alkylamines can include, for example, t-octylamine, 2-methylpentan-2-amine, 2-methylhexan-2-amine, 2-methylheptan-2-amine, 3-ethyloctan-3-amine, 3-ethylheptan-3-amine, 3-ethylhexan-3-amine, and the like. Additional branching can also be present. Without being bound by any theory or mechanism, it is believed that primary alkylamines can serve as ligands in the metal coordination sphere but be readily dissociable therefrom during metal nanoparticle consolidation. In some cases, at least a portion of a primary alkylamine may dissipate from the surface of the metal nanoparticles below a fusion temperature thereof during consolidation to form a metal matrix.

In some embodiments, the surfactant system can include a secondary amine. Secondary amines suitable for forming metal nanoparticles can include straight-chain, branched, or cyclic C₃-C₁₄, or C₃-C₈, or C₄-C₁₂, or C₄-C₈ alkyl groups bound to the amine nitrogen atom. The two alkyl groups can be the same or different. In some embodiments, the branching can occur on a carbon atom bound to the amine nitrogen atom in one or more of the alkyl groups, thereby producing significant steric encumbrance at the amine nitrogen atom. Suitable secondary amines can include, without limitation, dihexylamine, diisobutylamine, di-t-butylamine, dineopentylamine, di-(2-ethylhexyl)amine, di-t-pentylamine, dicyclopentylamine, dicyclohexylamine, and the like. Secondary amines outside the C₄-C₁₂ or C₄-C₈ range can also be used, but such secondary amines can have undesirable physical properties such as low boiling points or waxy consistencies that can complicate their handling. In some cases, at least a portion of a secondary alkylamine may dissipate from the surface of the metal nanoparticles below a fusion temperature thereof during consolidation to form a metal matrix.

In some embodiments, the surfactant system can include a diamine. In some embodiments, one or both of the nitrogen atoms of the diamine can be substituted with one or two alkyl groups. When two alkyl groups are present on the same nitrogen atom of the diamine, the alkyl groups can be the same or different. Further, when both nitrogen atoms are substituted, the same or different alkyl groups can be present. In some embodiments, the alkyl groups within the diamine can be C₁-C₆ alkyl groups. In other embodiments, the alkyl groups within the diamine can be C₁-C₄ alkyl groups or C₃-C₆ alkyl groups. In some embodiments, C₃ or higher alkyl groups within the diamine can be straight-chain or have branched chains. C₃ or higher alkyl groups within the diamine can be cyclic. Without being bound by any theory or mechanism, it is believed that diamines can facilitate metal nanoparticle formation by promoting nanoparticle nucleation.

Suitable diamines can include N,N′-dialkylethylenediamines, particularly C₁-C₄ N,N′-dialkylethylenediamines. The corresponding methylenediamine, propylenediamine, butylenediamine, pentylenediamine or hexylenediamine derivatives can also be used. The alkyl groups within the diamines can be the same or different. C₁-C₄ alkyl groups that can be present include, for example, methyl, ethyl, propyl, and butyl groups, or branched alkyl groups such as isopropyl, isobutyl, s-butyl, and t-butyl groups. Illustrative N,N′-dialkylethylenediamines that can be suitable for producing metal nanoparticles according to the disclosure herein include, for example, N,N′-di-t-butylethylenediamine, N,N′-diisopropylethylenediamine, and the like.

In some embodiments, suitable diamines can include N,N,N′,N′-tetraalkylethylenediamines, particularly C₁-C₄ N,N,N′,N′-tetraalkylethylenediamines. The corresponding methylenediamine, propylenediamine, butylenediamine, pentylenediamine or hexylenediamine derivatives can also be used. The alkyl groups can again be the same or different and include those mentioned above. Illustrative N,N,N′,N′-tetraalkylethylenediamines that can be suitable for use in forming metal nanoparticles include, for example, N,N,N′,N′-tetramethylethylenediamine, N,N,N′,N′-tetraethylethylenediamine, and the like.

In some examples, the one or more surfactants (surfactant system) used to produce compositions containing platelet nanoparticles may include at least one amine surfactant, more preferably two or more amine surfactants, and still more preferably three or more amine surfactants, such as the combination of a primary amine, a secondary amine, and a diamine. One or more or all of the amine surfactants may comprise a branched alkyl group. Thus, in some embodiments, a primary amine, a secondary amine, and a diamine may be used in conjunction with forming platelet nanoparticles, wherein the primary amine, the secondary amine, and the diamine each contain a branched alkyl group. Suitable examples of primary amines, secondary amines, and diamines include those listed above. When the surfactant system contains a primary amine, a secondary amine, and a diamine in combination, the ratios of the various surfactants with respect to one another in the solution of metal salt may be tailored to promote formation of platelet nanoparticles. Similarly, the ratio of these surfactants with respect to the metal salt may likewise be tailored to promote formation of platelet nanoparticles, such as through facilitating formation of the platelet nanoparticles under kinetic growth conditions.

In some examples, the secondary amine may be present in a higher molar amount than a combined amount of the primary amine and the bidentate amine. In some or other examples, the primary amine may be present in a higher molar amount than the bidentate amine. In non-limiting examples, a molar ratio of primary amine relative to the bidentate amine may range from about 0.9 to about 3.0, or about 1.0 to about 1.5, or about 1.5 to about 2.0, or about 2.0 to about 2.5, or about 2.5 to about 3.0, or about 1.6 to about 2.2, or about 2.1 to about 2.6, and a molar ratio of the secondary amine relative to the bidentate amine may range from about 2.5 to about 6.5, or about 2.5 to about 3.0, or about 3.0 to about 3.5, or about 3.5 to about 4.0, or about 4.0 to about 4.5, or about 4.5 to about 4.0, or about 5.0 to about 5.5, or about 5.5 or about 6.0, or about 6.0 to about 6.5, or about 3.1 to about 3.7, or about 3.7 to about 4.3, or about 4.3 to about 4.8. In some or other examples, a molar ratio of the primary amine relative to the metal salt may range from about 1.5 to about 2.5, or about 1.8 to about 2.3, or about 1.6 to about 2.1, or about 2.1 to about 2.4; a molar ratio of the secondary amine to the metal salt may range from about 4.0 to about 5.2, or about 4.0 to about 4.6, or about 4.6 to about 5.2, or about 4.4 to about 5.0, or about 4.6 to about 4.9; and a molar ratio of the bidentate amine to the metal salt may range from about 0.8 to about 1.6, or about 0.8 to about 1.3, or about 0.9 to about 1.2, or about 1.2 to about 1.6.

Surfactants other than aliphatic amines can also be present in the surfactant system. In this regard, suitable surfactants can include, for example, pyridines, aromatic amines, phosphines, thiols, or any combination thereof. These surfactants can be used in combination with an aliphatic amine, including those described above, or they can be used in a surfactant system in which an aliphatic amine is not present or one or more of a primary aliphatic amine, a secondary aliphatic amine, or a bidentate amine are omitted. Further disclosure regarding suitable pyridines, aromatic amines, phosphines, and thiols follows below.

Suitable aromatic amines can have a formula of ArNR¹R², where Ar is a substituted or unsubstituted aryl group and R¹ and R² are the same or different. R¹ and R² can be independently selected from H or an alkyl or aryl group containing from 1 to about 16 carbon atoms. Illustrative aromatic amines that can be suitable for use in forming metal nanoparticles include, for example, aniline, toluidine, anisidine, N,N-dimethylaniline, N,N-diethylaniline, and the like. Other aromatic amines that can be used in conjunction with metal nanoparticles can be envisioned by one having ordinary skill in the art.

Suitable pyridines can include both pyridine and its derivatives. Illustrative pyridines that can be suitable for promoting formation of metal nanoparticles include, for example, pyridine, 2-methylpyridine, 2,6-dimethylpyridine, collidine, pyridazine, and the like. Chelating pyridines such as bipyridyl chelating agents may also be used. Other pyridines that can be used in conjunction with formation of metal nanoparticles can be envisioned by one having ordinary skill in the art.

Suitable phosphines can have a formula of PR₃, where R is an alkyl or aryl group containing from 1 to about 16 carbon atoms. The alkyl or aryl groups attached to the phosphorus center can be the same or different. Illustrative phosphines that can be present when forming metal nanoparticles include, for example, trimethylphosphine, triethylphosphine, tributylphosphine, tri-t-butylphosphine, trioctylphosphine, triphenylphosphine, and the like. Phosphine oxides can also be used in a like manner. In some embodiments, surfactants that contain two or more phosphine groups configured for forming a chelate ring can also be used. Illustrative chelating phosphines can include 1,2-bisphosphines, 1,3-bisphosphines, and bis-phosphines such as BINAP, for example. Other phosphines potentially useful in conjunction with forming metal nanoparticles may also be envisioned by one having ordinary skill in the art.

Suitable thiols can have a formula of RSH, where R is an alkyl or aryl group having from about 4 to about 16 carbon atoms. Illustrative thiols that can be used in conjunction with forming metal nanoparticles include, for example, butanethiol, 2-methyl-2-propanethiol, hexanethiol, octanethiol, benzenethiol, and the like. In some embodiments, surfactants that contain two or more thiol groups configured for forming a chelate ring can also be used. Illustrative chelating thiols can include, for example, 1,2-dithiols (e.g., 1,2-ethanethiol) and 1,3-dithiols (e.g., 1,3-propanethiol). Other thiols potentially useful in conjunction with forming metal nanoparticles can also be envisioned by one having ordinary skill in the art.

Copper can be a particularly desirable metal for incorporation within metal nanoparticles due to its low cost, strength, and excellent electrical and thermal conductivity values, as well as additional advantages addressed further herein. Aliphatic amine surfactants, including those mentioned above, may also readily form metal-ligand bonds with copper and promote formation of copper nanoparticles. Although copper nanoparticles may be advantageous for the foregoing reasons, it is to be appreciated that other types of metal nanoparticles may be suitable for use in some instances. Other metal nanoparticles that may be formed according to the disclosure herein include, for example, aluminum nanoparticles, palladium nanoparticles, silver nanoparticles, gold nanoparticles, iron nanoparticles, cobalt nanoparticles, nickel nanoparticles, titanium nanoparticles, zirconium nanoparticles, hafnium nanoparticles, tantalum nanoparticles, and the like. Any of the foregoing metal nanoparticles may contain platelet nanoparticles in the disclosure herein, preferably in an amount over 20% based on total nanoparticles. Micron-sized particles of these metals may be present in nanoparticle pastes containing the metal nanoparticles as well, which may provide processing advantages in some cases.

Suitable alloys of copper may be formed in situ by co-reduction/precipitation during the initial process for forming the metal nanoparticles. In one configuration, an additional metal salt may be co-reduced with a copper salt. In another configuration, a metal organic compound that decomposes may be present during the reduction to form copper nanoparticles. In still another process configuration, a compound may be reduced or decomposed prior to forming copper nanoparticles in the same reaction vessel. In this configuration, nanoparticle nucleation seeds may be produced to promote growth of the metal nanoparticles around a nucleus. At least a portion of the metal nanoparticles produced in accordance with any of the foregoing may be platelet nanoparticles.

Accordingly, the present disclosure provides compositions comprising a plurality of metal nanoparticles having a surfactant coating thereon, in which at least a portion of the metal nanoparticles are platelet nanoparticles and the surfactant coating comprises at least one surfactant. More specifically, the compositions may comprise a plurality of metal nanoparticles having a surfactant coating thereon, in which at least 20% of the metal nanoparticles are platelet nanoparticles and the surfactant coating comprises at least one surfactant. The metal nanoparticles may comprise or consist essentially of copper nanoparticles in various instances. In some embodiments, platelet nanoparticles may comprise at least a majority of the metal nanoparticles.

Platelet nanoparticles may comprise about 20% to about 100% of the metal nanoparticles within the compositions on a volume basis. For example, the platelet nanoparticles may comprise about 20% or above, or about 30% or above, or about 40% or above, or about 50% or above, or about 60% or above, or about 70% or above, or about 80% or above, or about 90% or above, or about 95% or above of the plurality of metal nanoparticles.

The plurality of metal nanoparticles may further comprise a plurality of substantially spherical metal nanoparticles in addition to the platelet nanoparticles. The substantially spherical metal nanoparticles, when present, may have a diameter of about 150 nm or less, or about 70 nm or less, or about 20 nm or less, or about 10 nm or less, such as about 5 nm to about 20 nm, or about 10 nm to about 30 nm, or about 20 nm to about 50 nm, or about 50 nm to about 70 nm, or any combination thereof. When present, the substantially spherical metal nanoparticles may constitute from about 80% to about 10% of the plurality of metal nanoparticles on a volume basis. For example, the substantially spherical metal nanoparticles may comprise about 20% or less, or about 30% or less, or about 40% or less, or about 50% or less, or about 60% or less, or about 70% or less, or about 80% or less of the plurality of metal nanoparticles. In some embodiments, a plurality of substantially spherical metal nanoparticles having a bimodal particle size distribution may be present in combination with platelet nanoparticles of the present disclosure.

Substantially spherical metal nanoparticles may have a circularity of about 0.8 or greater, such as about 0.8 to about 1, or about 0.80 to about 0.95, or about 0.90 to about 1.0, or about 0.93 to about 0.99, or about 0.95 to about 0.99, or about 0.97 to about 0.99, or about 0.98 to about 1.0. To determine circularity of a given particle, the perimeter (P) and area (A) of the particle may be evaluated from an optical image. The circularity may then be determined from the relationship C_{EA}/P, where C_{EA} is the circumference of a circle having the area equivalent to the area (A) of the actual particle. Thus, circularity represents the ratio of the perimeter of the nanoparticles in comparison to that of a perfect sphere having the same radius. Platelet nanoparticles, in contrast, may have a circularity of 0.8 or less, such as 0.5 or less, or about 0.4 or less, or about 0.3 or less, or about 0.2 or less, provided that the platelet nanoparticles are not substantially round (disc-shaped). Disc-shaped platelet nanoparticles may have a circularity similar to that of substantially spherical metal nanoparticles.

In non-limiting examples, the platelet nanoparticles described herein may have a longitudinal thickness (i.e., though the plane of the platelet, thus representing a through-plane thickness) ranging from about 5 nm to about 40 nm, or about 5 nm to about 10 nm, or about 5 nm to about 20 nm, or about 10 nm to about 20 nm, or about 15 nm to about 30 nm, or about 20 nm to about 40 nm.

In non-limiting examples, the platelet nanoparticles described herein may have a largest dimension (any dimension, including though the plane of the platelet) ranging from about 10 nm to about 400 nm, or about 10 nm to about 100 nm, or about 50 nm to about 200 nm, or about 10 nm to about 50 nm, or about 100 nm to about 200 nm, or about 200 nm to about 400 nm.

In non-limiting examples, the platelet nanoparticles described herein may have a facial aspect ratio (ratio of length to width of the face of the platelet, not including the through-plane thickness of the platelet) ranging from about 1.5 to about 30, or about 1.5 to about 3, or about 2 to about 4, or about 3 to about 5, or about 5 to about 8, or about 8 to about 12, or about 10 to about 15, or about 12 to about 20, or about 15 to about 25, or about 15 to about 30, or about 20 to about 25, or about 25 to about 30.

In non-limiting examples, the platelet nanoparticles described herein may have a longitudinal aspect ratio (ratio of length or width to the longitudinal or through-plane thickness) ranging from about 1.5 to about 100, or about 1.5 to about 3, or about 2 to about 5, or about 3 to about 10, or about 5 to about 8, or about 8 to about 12, or about 10 to about 15, or about 12 to about 20, or about 15 to about 25, or about 15 to about 30, or about 20 to about 25, or about 25 to about 30, or about 20 to about 50, or about 30 to about 75, or about 35 to about 100.

In addition to the foregoing dimensions, the shape of the platelet nanoparticles is not believed to be particularly limited. In non-limiting examples, the platelet nanoparticles may have shapes such as, for example, triangular, rectangular, square, disc-like (including ovular and circular discs), pentagonal, hexagonal, the like, or any combination thereof.

For platelet nanoparticles that are not ovular or circular (i.e., polygonal platelet nanoparticles), the length of each edge may range from about 5 nm to about 400 nm in size, or about 5 nm to about 300 nm in size, or about 5 nm to about 200 nm in size, or about 10 nm to about 200 nm in size, or about 5 nm to about 50 nm in size, or about 5 nm to about 25 nm in size, or about 50 nm to about 100 nm in size. In non-limiting examples, triangular platelet nanoparticles may have edges ranging from about 5 nm to about 200 nm in size, and hexagonal platelet nanoparticles may have edges ranging from about 5 nm to about 150 nm in size. The foregoing values represent the edge lengths, rather than the largest dimension (apothem) of the platelet nanoparticles. The length of each edge in platelet nanoparticles may be the same or different. Thus, polygonal platelet nanoparticles may be regular or irregular in shape. The vertices of polygonal platelet nanoparticles may be rounded in some cases.

The compositions containing platelet nanoparticles described hereinabove may be further incorporated within various nanoparticle formulations, which may facilitate dispensation of the platelet nanoparticles and consolidation thereof. Suitable formulations may include nanoparticle pastes, sprayable formulations, inks, or the like. Illustrative disclosure directed to such nanoparticle pastes and similar formulations follows hereinafter. Again, copper nanoparticles (e.g., copper nanoparticles having a platelet morphology, optionally in combination with substantially spherical copper nanoparticles) represents but one type of metal nanoparticle that may be suitably incorporated in a nanoparticle paste and further consolidated according to the disclosure herein.

Nanoparticle pastes can be prepared by dispersing as-produced or as-isolated metal nanoparticles in an organic matrix containing one or more organic solvents and various other optional components. As used herein, the terms “nanoparticle paste formulation” and “nanoparticle paste” are used interchangeably and refer synonymously to a fluid composition containing dispersed metal nanoparticles that is suitable for dispensation using a desired technique. Suitable pastes may include fluid dispersions that are not freely flowing due to their viscosity, whereas fluid dispersions, including inks, may be freely flowing. Use of the term “paste” does not necessarily imply an adhesive function of the paste alone. Through judicious choice of the organic solvent(s) and other additives in a nanoparticle paste, the loading of metal nanoparticles, and the like, dispensation of the metal nanoparticles in a desired location may be promoted.

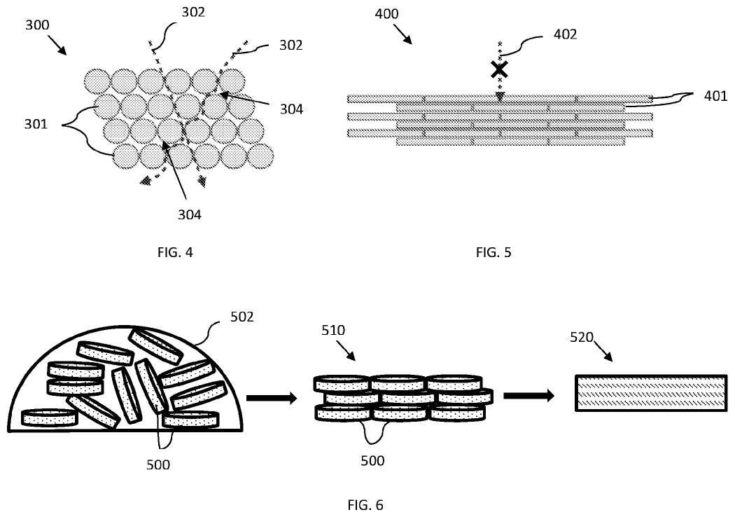

Cracking and shrinkage can sometimes occur during consolidation of metal nanoparticles, particularly when substantially spherical metal nanoparticles are used. Platelet nanoparticles, in contrast, overlap one another much more effectively than do substantially spherical metal nanoparticles, thereby making it harder for cracks to develop and propagate. FIG. 4 is a diagram showing substantially spherical metal nanoparticles 301 in a close packing configuration 300. As shown, even a close packing configuration 300 provides a route for crack progression 302 through consolidated grain boundaries 304 after formation thereof. FIG. 5 is a diagram showing platelet nanoparticles 401 in an overlapping, stacked packing configuration 400. As shown, in the case of stacked platelet nanoparticles 401, there is not a contiguous pathway through which crack progression 402 may easily proceed.

One way in which nanoparticle pastes containing platelet nanoparticles can further promote a decreased degree of cracking and void formation following metal nanoparticle consolidation is by maintaining a high solids content. Thus, nanoparticle pastes disclosed herein can contain at least about 30% metal nanoparticles by weight, particularly about 30% to about 98% metal nanoparticles by weight of the nanoparticle paste, or about 50% to about 98% metal nanoparticles by weight of the nanoparticle paste, or about 70% to about 98% metal nanoparticles by weight of the nanoparticle paste. Moreover, in some embodiments, small amounts (e.g., about 0.01% to about 15%, or about 35% to about 70%, or about 10% to about 35% by weight of the paste composition) of micron-scale metal particles can be present in addition to the metal nanoparticles. Such micron-scale metal particles can desirably promote the fusion of metal nanoparticles into a bulk metal matrix and further reduce the incidence of cracking, shrinkage, and overall porosity. For example, shrinkage upon forming fused copper nanoparticles may decrease to about 5 vol. % or less in the presence of micron-scale particles as compared to shrinkage rates of about 20-40 vol. % when micron-scale particles are not present. Decreased shrinkage may be realized when platelet nanoparticles are present in nanoparticle pastes and similar formulations, even when micron-scale metal particles are not present, thereby allowing micron-scale metal nanoparticles to be used in lower amounts or not at all in the nanoparticle pastes disclosed herein. The decreased shrinkage may result from the platelet nanoparticles being closer together from the outset as a result of improved stacking. Instead of being liquefied and undergoing direct consolidation, the micron-scale metal particles, when present, can simply become joined together upon being contacted with metal nanoparticles that have been raised above their fusion temperature. Moreover, platelet nanoparticles may provide better contact between two or more micron-scale metal particles (further aided by flexibility of the platelet nanoparticles in some cases), thereby bridging the micron-scale metal particles together once raised above the fusion temperature. These factors can reduce the porosity that results after fusing the platelet nanoparticles and micron-scale metal particles together. The micron-scale metal particles can contain the same or different metals than the metal nanoparticles. For example, micron-scale copper particles may be used in combination with copper nanoparticles containing at least some platelet nanoparticles. Suitable metals for the micron-scale metal particles can include, for example, copper, silver, gold, aluminum, tin, and the like. Micron-scale graphite particles may also be included as another type of micron-scale particle. Carbon nanotubes and/or graphene may be included as still another type of micron-scale particle. Carbon black and/or nanocarbon may be included in still other instances. Still other additives, such as diamond particles, AlN, and cubic BN (boron nitride), for example, may be included as well. Suitable forms for the additional additives may include, for example, milled fibers having a length of about 50 microns to about 350 microns and a diameter of about 5 microns to about 25 microns.

Decreased cracking and void formation during metal nanoparticle consolidation can also be promoted by judicious choice of the solvent(s) forming the organic matrix present in a nanoparticle paste or similar formulation. A tailored combination of organic solvents can desirably decrease the incidence of cracking and void formation. More particularly, an organic matrix containing one or more hydrocarbons (saturated, monounsaturated, polyunsaturated (2 or more double bonds) or aromatic), one or more alcohols, one or more amines, and optionally one or more organic acids can be especially effective for this purpose. One or more esters, ethers, ketones, aldehydes, and/or one or more anhydrides may be included, in some embodiments, in addition or as an alternative to other solvent components of the nanoparticle paste. Without being bound by any theory or mechanism, it is believed that this combination of organic solvents can facilitate the removal and sequestration of surfactant molecules surrounding the metal nanoparticles during consolidation, such that the metal nanoparticles can more easily fuse together with one another. More particularly, it is believed that hydrocarbon and alcohol solvents can passively solubilize surfactant molecules released from the metal nanoparticles by Brownian motion and reduce their ability to become re-attached thereto. In concert with the passive solubilization of surfactant molecules, amine and organic acid solvents can actively sequester the surfactant molecules through a chemical interaction such that they are no longer available for recombination with the metal nanoparticles.

Further tailoring of the solvent composition can be performed to reduce the suddenness of volume contraction that takes place during surfactant removal and metal nanoparticle consolidation. Specifically, more than one member of each class of organic solvent (i.e., hydrocarbons, alcohols, amines, and optional organic acids), can be present in the organic matrix, where the members of each class have boiling points that are separated from one another by a set degree. For example, in some embodiments, the various members of each class can have boiling points that are separated from one another by about 20° C. to about 50° C. By using such a solvent mixture, sudden volume changes due to rapid loss of solvent can be minimized during metal nanoparticle consolidation, since the various components of the solvent mixture can be removed gradually over a broad range of boiling points (e.g., about 50° C. to about 250° C.).

In some embodiments, at least some of the one or more organic solvents can have a boiling point of about 100° C. or greater. In some embodiments, at least some of the one or more organic solvents can have a boiling point of about 200° C. or greater or about 300° C. or greater. In some embodiments, the one or more organic solvents can have boiling points ranging between about 50° C. and about 350° C., or between about 50° C. and about 200° C., or between about 100° C. and about 200° C., or between about 150° C. and about 350° C. Use of high boiling organic solvents can desirably increase the pot life of the nanoparticle pastes and limit the rapid loss of solvent, which can lead to cracking and void formation during nanoparticle consolidation. In some embodiments, at least one of the organic solvents can have a boiling point that is higher than the boiling point(s) of the surfactant(s) associated with the metal nanoparticles. Accordingly, surfactant(s) can be removed from the metal nanoparticles by evaporation before removal of the organic solvent(s) takes place, and in some examples, at least a portion of the surfactant(s) may be removed below the fusion temperature of the metal nanoparticles.

In some embodiments, the organic matrix can contain one or more alcohols. In various embodiments, the alcohols can include monohydric alcohols, diols, triols, glycol ethers (e.g., diethylene glycol and triethylene glycol), alkanolamines (e.g., ethanolamine, triethanolamine, and the like), or any combination thereof. In some embodiments, one or more hydrocarbons can be present in combination with one or more alcohols. As discussed above, it is believed that alcohol and hydrocarbon solvents can passively promote the solubilization of surfactants as they are removed from the metal nanoparticles by Brownian motion and limit their re-association with the metal nanoparticles. Moreover, hydrocarbon and alcohol solvents only weakly coordinate with metal nanoparticles, so they do not simply replace the displaced surfactants in the nanoparticle coordination sphere. Illustrative but non-limiting examples of alcohol and hydrocarbon solvents that can be present include, for example, light aromatic petroleum distillate (CAS 64742-95-6), hydrotreated light petroleum distillates (CAS 64742-47-8), tripropyleneglycol methyl ether, ligroin (CAS 68551-17-7, a mixture of C₁₀-C₁₃ alkanes), diisopropyleneglycol monomethyl ether, diethyleneglycol diethyl ether, 2-propanol, 2-butanol, t-butanol, 1-hexanol, 2-(2-butoxyethoxy)ethanol, and terpineol. In some embodiments, polyketone solvents can be used in a like manner.

In some embodiments, the organic matrix can contain one or more amines and optionally one or more organic acids. In some embodiments, the one or more amines and one or more organic acids can be present in an organic matrix that also includes one or more hydrocarbons and one or more alcohols. As discussed above, it is believed that amines and organic acids can actively sequester surfactants that have been passively solubilized by hydrocarbon and alcohol solvents, thereby making the surfactants unavailable for re-association with the metal nanoparticles. Thus, an organic solvent that contains a combination of one or more hydrocarbons, one or more alcohols, one or more amines, and one or more organic acids can provide synergistic benefits for promoting the consolidation of metal nanoparticles. Illustrative but non-limiting examples of amine solvents that can be present include, for example, tallowamine (CAS 61790-33-8), alkyl (C₈-C₁₈) unsaturated amines (CAS 68037-94-5), di(hydrogenated tallow)amine (CAS 61789-79-5), dialkyl (C₈-C₂₀) amines (CAS 68526-63-6), alkyl (C₁₀-C₁₆)dimethyl amine (CAS 67700-98-5), alkyl (C₁₄-C₁₈) dimethyl amine (CAS 68037-93-4), dihydrogenated tallowmethyl amine (CAS 61788-63-4), and trialkyl (C₆-C₁₂) amines (CAS 68038-01-7). Illustrative but non-limiting examples of organic acid solvents that can be present in the nanoparticle pastes include, for example, octanoic acid, nonanoic acid, decanoic acid, caprylic acid, pelargonic acid, undecylic acid, lauric acid, tridecylic acid, myristic acid, pentadecanoic acid, palmitic acid, margaric acid, stearic acid, nonadecylic acid, α-linolenic acid, stearidonic acid, oleic acid, and linoleic acid.

In some embodiments, the organic matrix can include more than one hydrocarbon, more than one alcohol, more than one amine, and more than one optional organic acid. For example, in some embodiments, each class of organic solvent can have two or more members, or three or more members, or four or more members, or five or more members, or six or more members, or seven or more members, or eight or more members, or nine or more members, or ten or more members. Moreover, the number of members in each class of organic solvent can be the same or different. Particular benefits of using multiple members of each class of organic solvent are described hereinafter.

One particular advantage of using multiple members within each class of organic solvent can include the ability to provide a wide spread of boiling points in the nanoparticle pastes. By providing a wide spread of boiling points, the organic solvents can be removed gradually as the temperature rises while affecting metal nanoparticle consolidation, thereby limiting volume contraction and disfavoring cracking. Greater structural integrity of a connection may be realized as a result. By gradually removing the organic solvent in this manner, less temperature control may be needed to promote slow solvent removal than if a single solvent with a narrow boiling point range was used. In some embodiments, the members within each class of organic solvent can have a window of boiling points ranging between about 50° C. and about 200° C., or between about 50° C. and about 250° C., or between about 100° C. and about 200° C., or between about 100° C. and about 250° C. Boiling points up to about 350° C. may be suitable in some cases. In more particular embodiments, the various members of each class of organic solvent can each have boiling points that are separated from one another by at least about 20° C., specifically about 20° C. to about 50° C. More specifically, in some embodiments, each hydrocarbon can have a boiling point that differs by about 20° C. to about 50° C. from other hydrocarbons in the organic matrix, each alcohol can have a boiling point that differs by about 20° C. to about 50° C. from other alcohols in the organic matrix, each amine can have a boiling point that differs by about 20° C. to about 50° C. from other amines in the organic matrix, and each optional organic acid can have a boiling point that differs by about 20° C. to about 50° C. from other organic acids in the organic matrix. The more members of each class of organic solvent that are present, the smaller the differences become between the boiling points. By having smaller differences between the boiling points, solvent removal can be made more continual, thereby limiting the degree of volume contraction that occurs at each stage. A reduced degree of cracking can occur when four to five or more members of each class of organic solvent are present (e.g., four or more hydrocarbons, four or more alcohols, four or more amines, and four or more organic acids; or five or more hydrocarbons, five or more alcohols, five or more amines, and five or more organic acids), each having boiling points that are separated from one another within the above range.

In addition to metal nanoparticles and organic solvents, other additives can also be present in the nanoparticle pastes, including the micron-scale metal particles or other micron-scale particles mentioned above. Such additional additives can include, for example, rheology control aids, thickening agents, micron-scale conductive additives, nanoscale conductive additives, and any combination thereof. Chemical additives can also be present. As discussed hereinafter, the inclusion of micron-scale conductive additives, such as micron-scale metal particles, can be particularly advantageous. Nanoscale or micron-scale diamond or other thermally conductive additives may be desirable to include in some instances.

In some embodiments, the nanoparticle pastes can contain about 0.01% to about 15% micron-scale metal particles by weight, or about 1% to about 10% micron-scale metal particles by weight, or about 1% to about 5% micron-scale metal particles by weight, or about 0.1% to about 35% micron-scale particles by weight, or about 10% to about 35% micron-scale particles by weight, or about 35% to about 70% micron-scale particles by weight. Inclusion of micron-scale metal particles in the nanoparticle pastes can desirably reduce the incidence of cracking that occurs during consolidation of the metal nanoparticles due to shrinkage. Again, use of platelet nanoparticles may decrease the incidence of shrinkage and cracking compared to substantially spherical metal nanoparticles, even when micron-scale metal particles are omitted or used in lower amounts. Without being bound by any theory or mechanism, it is believed that the micron-scale metal particles can become partially consolidated with one another as the metal nanoparticles are liquefied and form a transient liquid coating upon the micron-scale metal particles and filling voids therebetween. In essence, the metal nanoparticles function as a “glue” binding the micron-scale particles together. In some embodiments, the micron-scale metal particles can range between about 500 nm to about 100 microns in size in at least one dimension, or from about 500 nm to about 10 microns in size in at least one dimension, or from about 100 nm to about 5 microns in size in at least one dimension, or from about 100 nm to about 10 microns in size in at least one dimension, or from about 100 nm to about 1 micron in size in at least one dimension, or from about 1 micron to about 10 microns in size in at least one dimension, or from about 5 microns to about 10 microns in size in at least one dimension, or from about 1 micron to about 100 microns in size in at least one dimension. The micron-size metal particles can contain the same metal as the metal nanoparticles or contain a different metal. Thus, metal alloys can be fabricated by including micron-size metal particles in the nanoparticle pastes with a metal differing from that of the metal nanoparticles. Suitable micron-scale metal particles can include, for example, Cu, Ni, Al, Fe, Co, Mo, Ag, Zn, Sn, Au, Pd, Pt, Ru, Mn, Cr, Ti, V, Mg or Ca particles. Borides, carbides, phosphides, nitrides, and silicides of these metals, and combinations thereof may be used as well. Non-metal particles such as, for example, Si and B micron-scale particles can be used in a like manner, including borides, carbides, phosphides, nitrides, and silicides thereof. Specific examples of particles that may be present in the nanoparticle pastes include SiC, AlN, SiN, BN, and the like. In some embodiments, the micron-scale metal particles can be in the form of metal flakes, such as high aspect ratio copper flakes, for example. That is, in some embodiments, the nanoparticle pastes described herein can contain a mixture of copper nanoparticles and high aspect ratio copper flakes. Specifically, in some embodiments, the nanoparticle pastes can contain about 30% to about 98% copper nanoparticles by weight and about 0.01% to about 15% high aspect ratio copper flakes by weight, or about 0.1% to about 35% high aspect ratio copper flakes by weight, or about 1% to about 35% high aspect ratio copper flakes by weight, or about 35% to about 70% high aspect ratio copper flakes by weight.

Other micron-scale metal particles that can be used equivalently to high aspect ratio metal flakes include, for example, metal nanowires and other high aspect ratio particles, which can be up to about 300 microns or about 500 microns in length. The ratio of metal nanoparticles to metal nanowires may range between about 10:1 to about 40:1, according to various embodiments. Suitable nanowires may have a length of between about 5 microns and about 50 microns or about 100 microns, and a diameter between about 100 nm and about 200 nm, for example. Milled fibers (e.g., carbon fibers, ceramic fiber, metallic fibers, and like fibers having high thermal conductivity) may be used similarly. In non-limiting examples, suitable milled fibers may have a diameter of about 5 microns to about 25 microns and a length of about 50 microns to about 500 microns.

In some embodiments, nanoscale conductive additives can also be present in the nanoparticle pastes. These additives can desirably provide further structural reinforcement and reduce shrinkage during metal nanoparticle consolidation. Moreover, inclusion of nanoscale conductive additives can increase electrical and thermal conductivity values that can approach or even exceed that of the corresponding bulk metal following nanoparticle consolidation. In some embodiments, the nanoscale conductive additives can have a size in at least one dimension ranging between about 1 micron and about 100 microns, or ranging between about 1 micron and about 300 microns. Suitable nanoscale conductive additives can include, for example, carbon nanotubes, graphene, and the like. Carbon fibers of nanoscale dimension may be used similarly. When present, the nanoparticle pastes can contain about 1% to about 15% nanoscale conductive additives by weight, or about 1% to about 10% nanoscale conductive additives by weight, or about 1% to about 5% nanoscale conductive additives by weight.

Additional substances that can also optionally be present include, for example, flame retardants, UV protective agents, antioxidants, carbon black, graphite, fiber materials (e.g., chopped carbon fiber materials), diamond, and the like.

In addition to nanoparticle pastes, the metal nanoparticles disclosed herein may be incorporated within sprayable formulations and inks that may be dispensed by alternative procedures such as inkjet printing, stencil printing, gravure printing, aerosol spraying, painting, dip-coating, 3-D printing and the like. Sprayable formulations and inks may similarly comprise the metal nanoparticles dispersed in a suitable solvent but have a lower viscosity than do the above-described nanoparticle pastes. Suitable sprayable formulations may have a viscosity of about 1 cP to about 500 cP or about 1 cP to about 100 cP and contain a loading of metal nanoparticles, at least about 20% of which are platelet nanoparticles, ranging from about 1 wt. % to about 35 wt. %, or about 10 wt. % to about 25 wt. %, or about 1 wt. % to about 10 wt. %, or about 10 wt. % to about 15 wt. %. Sprayable formulations and inks containing the metal nanoparticles may comprise one or more organic solvents and optionally water, in which the metal nanoparticles may be dispersed prior to dispensation upon a substrate. Where needed, additional additives may be present in sprayable formulations and inks as well. Sprayable formulations may be dispensed using an aerosol propellant, forced pressurization, suction, or mechanical pumping, as non-limiting examples.

Methods for consolidating metal nanoparticles comprising platelet nanoparticles may comprise depositing the metal nanoparticles upon a substrate, and consolidating the metal nanoparticles to form a bulk metal matrix upon the substrate. Suitable substrates are not believed to be especially limited. In various embodiments, consolidating the metal nanoparticles may comprise heating the metal nanoparticles at or above a fusion temperature thereof. Solvent removal from a metal nanoparticle paste may occur during consolidation, which may further facilitate packing of platelet nanoparticles as shown in FIG. 6.

FIG. 6 is a diagram showing how platelet nanoparticles may undergo stacking and consolidation with one another. As shown in FIG. 6, platelet nanoparticles 500 may initially be randomly distributed in the solvent of nanoparticle paste 502. As the solvent gradually dissipates from the surface of a substrate, platelet nanoparticles 500 may become organized into stacked configuration 510, in which platelet nanoparticles 500 are layered upon one another, either in an overlapping or non-overlapping manner. Following consolidation of platelet nanoparticles 500 at or above the fusion temperature, bulk metal matrix 520 may result.

Embodiments disclosed herein include:

A. Platelet nanoparticle compositions. The compositions comprise: a plurality of metal nanoparticles having a surfactant coating thereon, at least a portion of the metal nanoparticles being platelet nanoparticles and the surfactant coating comprising at least one surfactant.

A1. Nanoparticle pastes comprising the composition of A.

A2. Sprayable formulations comprising the composition of A.

A3. Inks comprising the composition of A.

B. Methods for forming bulk metal. The methods comprise: depositing the metal nanoparticles of A upon a substrate, and consolidating the metal nanoparticles to form a bulk metal matrix.

C. Methods for forming platelet nanoparticles. The methods comprise: providing a solution comprising a metal salt and at least one surfactant dissolved in an organic solvent; and adding a reducing agent to the solution at a rate sufficient to form a plurality of metal nanoparticles in which at least a portion of the metal nanoparticles are platelet nanoparticles, the metal nanoparticles having a surfactant coating comprising at least one surfactant thereon; wherein the reducing agent is added at a rate sufficient to maintain the solution at a temperature of about 60° C. or below while forming the metal nanoparticles.

Embodiments A-C may have one or more of the following additional elements in any combination:

Element 1: wherein the platelet nanoparticles have a thickness ranging from about 5 nm to about 40 nm.

Element 2: wherein the platelet nanoparticles have a longitudinal aspect ratio ranging from about 1 to about 100.

Element 3: wherein the platelet nanoparticles have a largest dimension ranging from about 10 nm to about 400 nm.

Element 4: wherein the plurality of metal nanoparticles further comprises a plurality of substantially spherical metal nanoparticles.

Element 5: wherein the metal nanoparticles comprise copper nanoparticles.

Element 6: wherein the at least one surfactant comprises at least one amine surfactant.

Element 7: wherein the at least one amine surfactant comprises two or more amine surfactants, at least one of the two or more amine surfactants being a N,N′-dialkylethylenediamine.

Element 8: wherein the platelet nanoparticles are atomically flat.

Element 9: wherein consolidating the metal nanoparticles comprises heating the nanoparticle paste above a fusion temperature of the metal nanoparticles.

Element 10: wherein the reducing agent is added to the solution over about 10 minutes or more.

Element 11: wherein the temperature of the solution rises about 10° C. to about 15° C. while adding the reducing agent.

Element 12: wherein the reducing agent is added at rate sufficient to maintain the solution at a temperature of about 40° C. to about 60° C. while forming the metal nanoparticles.

By way of non-limiting example, exemplary combinations applicable to A-C include, but are not limited to, 1, 2, and/or 3, and 4; 1, 2, and/or 3, and 5; 1, 2, and/or 3, and 6; 1, 2, and/or 3, and 7; 1, 2, and/or 3, and 8; 1 and 2; 1 and 3; 1 and 4; 1 and 5; 1 and 6; 1 and 7; 1 and 8; 2 and 3; 2 and 4; 2 and 5; 2 and 6; 2 and 7; 2 and 8; 3 and 4; 3 and 5; 3 and 6; 3 and 7; 3 and 8; 4 and 5; 4 and 6; 4 and 7; 4 and 8; 5 and 6; 5 and 7; 5 and 8; 6 and 7; 6 and 8; and 7 and 8. Any of the foregoing may be in further combination with one or more of 9, 10, 11 and/or 12. Additional exemplary combinations applicable to C include, but are not limited to, 10 and 11; 10 and 12; 11 and 12; and 10-12.

Additional embodiments disclosed herein include:

Embodiment 1. A composition comprising:
a plurality of metal nanoparticles having a surfactant coating thereon, at least about 20% of the metal nanoparticles being platelet nanoparticles and the surfactant coating comprising at least one surfactant.

Embodiment 2. The composition of embodiment 1, wherein at least a majority of the metal nanoparticles are platelet nanoparticles.

Embodiment 3. The composition of embodiment 1, or the composition of embodiment 1 or embodiment 2, wherein at least about 80% of the metal nanoparticles are platelet nanoparticles.

Embodiment 4. The composition of embodiment 1, or the composition of any one of embodiments 1-3, wherein the platelet nanoparticles have a longitudinal thickness ranging from about 5 nm to about 40 nm.

Embodiment 5. The composition of embodiment 1, or the composition of any one of embodiments 1-4, wherein the platelet nanoparticles have a longitudinal aspect ratio ranging from about 1 to about 100.

Embodiment 6. The composition of embodiment 1, or the composition of any one of embodiments 1-5, wherein the platelet nanoparticles have a largest dimension ranging from about 10 nm to about 400 nm.

Embodiment 7. The composition of any one of embodiments 1-6, wherein the plurality of metal nanoparticles further comprises a plurality of substantially spherical metal nanoparticles.

Embodiment 8. The composition of any one of embodiments 1-6, or the composition of any one of embodiments 1-7, wherein the metal nanoparticles comprise copper nanoparticles.

Embodiment 9. The composition of any one of embodiments 1-6, or the composition of any one of embodiments 1-8, wherein the at least one surfactant comprises at least one amine surfactant.

Embodiment 10. The composition of embodiment 9, wherein the at least one amine surfactant comprises two or more amine surfactants.

Embodiment 11. The composition of embodiment 9, or the composition of embodiment 9 or embodiment 10, wherein the at least one amine surfactant comprises one or more branched amines.

Embodiment 12. The composition of any one of embodiments 1-6, or the composition of any one of embodiments 1-11, wherein the platelet nanoparticles have a fusion temperature ranging from about 180° C. to about 240° C.

Embodiment 13. A nanoparticle paste comprising the composition of any one of embodiments 1-6, or the composition of any one of embodiments 1-12.

Embodiment 14. A sprayable formulation comprising the composition of any one of embodiments 1-6, or the composition of any one of embodiments 1-12.

Embodiment 15. An ink comprising the composition of any one of embodiments 1-6, or the composition of any one of embodiments 1-12.

Embodiment 16. A method comprising:
depositing the composition of any one of embodiments 1-6 or the composition of any one of embodiments 1-13 upon a substrate; and
consolidating the metal nanoparticles to form a bulk metal matrix upon the substrate.

Embodiment 17. The method of embodiment 16, wherein consolidating the metal nanoparticles comprises heating the composition above a fusion temperature of the metal nanoparticles.

Embodiment 18. The method of embodiment 16, or the method of embodiment 16 or embodiment 17, wherein the platelet nanoparticles have a fusion temperature ranging from about 180° C. to about 240° C.

Embodiment 19. The method of embodiment 16, or the method of any one of embodiments 16-18, wherein the plurality of metal nanoparticles further comprises a plurality of substantially spherical metal nanoparticles.

Embodiment 20. The method of embodiment 16, or the method of any one of embodiments 16-19, wherein the metal nanoparticles comprise copper nanoparticles.

Embodiment 21. The method of embodiment 16, or the method of any one of embodiments 16-20, wherein the at least one surfactant comprises at least one amine surfactant.

Embodiment 22. The method of embodiment 21, wherein the at least one amine surfactant comprises two or more amine surfactants.

Embodiment 23. The method of embodiment 21, or the method of embodiment 21 or embodiment 22, wherein the at least one amine surfactant comprises one or more branched amines.

Embodiment 24. The method of embodiment 21, or the method of any one of embodiments 21-23, wherein at least a portion of the at least one amine surfactant is removed from the metal nanoparticles below a fusion temperature of the metal nanoparticles when consolidating the metal nanoparticles.

Embodiment 25. A method comprising:
providing a solution comprising a metal salt and at least one surfactant dissolved in an organic solvent; and
adding a reducing agent to the solution at a rate sufficient to form a plurality of metal nanoparticles in which at least about 20% of the metal nanoparticles are platelet nanoparticles, the metal nanoparticles having a surfactant coating comprising at least some of the at least one surfactant;
wherein the reducing agent is added at a rate sufficient to maintain the solution at a temperature of about 70° C. or below while forming the metal nanoparticles.

Embodiment 26. The method of embodiment 25, wherein the at least one surfactant comprises at least one amine surfactant.

Embodiment 27. The method of embodiment 26, or the method of embodiment 25 or embodiment 26, wherein the at least one amine surfactant comprises two or more amine surfactants.

Embodiment 28. The method of embodiment 26, or the method of embodiment 26 or embodiment 27, wherein the at least one amine surfactant comprises a primary amine, a secondary amine, and a bidentate amine.

Embodiment 29. The method of embodiment 28, wherein the secondary amine is present in a higher molar amount than a combined amount of the primary amine and the bidentate amine.

Embodiment 30. The method of embodiment 28, wherein the primary amine is present in a higher molar amount than the bidentate amine.

Embodiment 31. The method of embodiment 26, or the method of any one of embodiments 26-30, wherein the at least one amine surfactant comprises one or more branched amines.

Embodiment 32. The method of embodiment 25, or the method of any one of embodiments 25-31, further comprising:
after adding the reducing agent, cooling the solution to room temperature over at least about 30 minutes.

Embodiment 33. The method of any one of embodiments 25-32, wherein at least a majority of the metal nanoparticles are platelet nanoparticles.

Embodiment 34. The method of any one of embodiments 25-32, or the method of any one of embodiments 25-33, wherein at least about 80% of the metal nanoparticles are platelet nanoparticles.

Embodiment 35. The method of any one of embodiments 25-32, or the method of any one of embodiments 25-34, wherein the plurality of metal nanoparticles further comprises a plurality of substantially spherical metal nanoparticles.

Embodiment 36. The method of any one of embodiments 25-32, or the method of any one of embodiments 25-35, wherein the metal nanoparticles comprise copper nanoparticles.

Embodiment 37. The method of any one of embodiments 25-32, or the method of any one of embodiments 25-36, wherein the platelet nanoparticles have a longitudinal thickness ranging from about 5 nm to about 40 nm.

Embodiment 38. The method of any one of embodiments 25-32, or the method of any one of embodiments 25-37, wherein the platelet nanoparticles have a longitudinal aspect ratio ranging from about 1 to about 100.

Embodiment 39. The method of any one of embodiments 25-32, or the method of any one of embodiments 25-38, wherein the platelet nanoparticles have a largest dimension ranging from about 10 nm to about 400 nm.

Embodiment 40. The method of any one of embodiments 25-32, or the method of any one of embodiments 25-39, wherein the platelet nanoparticles have a fusion temperature ranging from about 180° C. to about 240° C.

Embodiment 41. The method of any one of embodiments 25-32, or the method of any one of embodiments 25-40, wherein the reducing agent is added at rate sufficient to maintain the solution at a temperature of about 40° C. to about 70° C. while forming the metal nanoparticles.

Embodiment 42. The method of any one of embodiments 25-32, or the method of any one of embodiments 25-41, wherein the temperature of the solution rises about 10° C. to about 15° C. while adding the reducing agent.

Embodiment 43. The method of any one of embodiments 25-32, or the method of any one of embodiments 25-42, wherein no external heating is applied to the solution while forming the metal nanoparticles.

To facilitate a better understanding of the present disclosure, the following examples of preferred or representative embodiments are given. In no way should the following examples be read to limit, or to define, the scope of the invention.

### EXAMPLES

General synthesis conditions for producing platelet nanoparticles. Copper platelet nanoparticles are prepared by reduction of a copper salt with slow addition of a reducing agent, while maintaining the reaction at a temperature where platelet nanoparticles are formed. In brief, a copper metal precursor (copper salt), such as copper (II) chloride, copper (II) bromide, or copper (II) sulfate, is dispersed in a glyme solvent at a concentration of 0.25-11 wt. % based on dissolved metal ions from the salt. A surfactant mixture containing one, two, three, or four surfactants is then added at a mole ratio of total surfactants to copper metal precursor of at least 4.1:1. After dissolving the copper salt and thorough mixing over a period of 2-3 hours, a sufficient amount of reducing agent to form copper platelet nanoparticles is slowly added over a period of 7-45 minutes such that the temperature exceeded 35° C. The reaction mixture is then cooled to room temperature over a period of 20-90 minutes, and platelet nanoparticles are isolated by centrifugation.

Specific synthesis conditions for producing platelet nanoparticles (Experimental). Copper platelet nanoparticles were prepared by slow reduction of copper (II) chloride in glyme with NaBH₄. Specifically, the copper salt was dispersed in glyme solvent at a concentration of at least 0.95 wt. % based on dissolved metal ions and a surfactant mixture containing a bidentate amine, a primary amine, and a secondary amine was added at an overall mole ratio of amine surfactants to copper of at least 5.7. The individual amine surfactants were present such that the bidentate amine was present in the lowest molar amount and the secondary amine was present in the highest molar amount. After thorough mixing, about 1.0-1.5 equivalents of NaBH₄ relative to dissolved metal ions was slowly added at a steady rate over a period of at least 7 minutes. The rate of addition was controlled such that the temperature surpassed 35° C. Thereafter, the reaction mixture was slowly cooled to room temperature over a period of at least 20 minutes, and copper platelet nanoparticles were isolated via centrifugation. The isolated copper platelet nanoparticles were washed with water and stored while still wet. The still wet product can be stored safely for several years at room temperature in a well-sealed container.

Specific synthesis conditions for producing spherical nanoparticles (Comparative). Substantially spherical copper nanoparticles were prepared by rapid reduction of copper (II) chloride in glyme with NaBH₄. Specifically, the copper salt was dispersed in glyme solvent at a concentration of 0.40-0.50 wt. % based on dissolved metal ions from the copper salt, and a surfactant mixture containing a bidentate amine, a primary amine, and a secondary amine was added at an overall mole ratio of amine surfactants to copper of at least 4.1. The individual amine surfactants were present such that the bidentate amine and the primary amine were present in approximately equal molar amounts, and the secondary amine was present in the greatest molar amount. After thorough mixing, about 1.0 equivalent of NaBH₄ relative to dissolved metal ions was added rapidly over a period of less than 3 minutes. At the rapid addition rate, the temperature peaked near 45° C. Thereafter, the reaction mixture was rapidly cooled to room temperature over a period not exceeding 10 minutes, and substantially spherical copper nanoparticles were isolated via centrifugation. The isolated copper platelet nanoparticles were washed with water and stored while still wet. The still wet product can be stored safely for several years at room temperature in a well-sealed container.

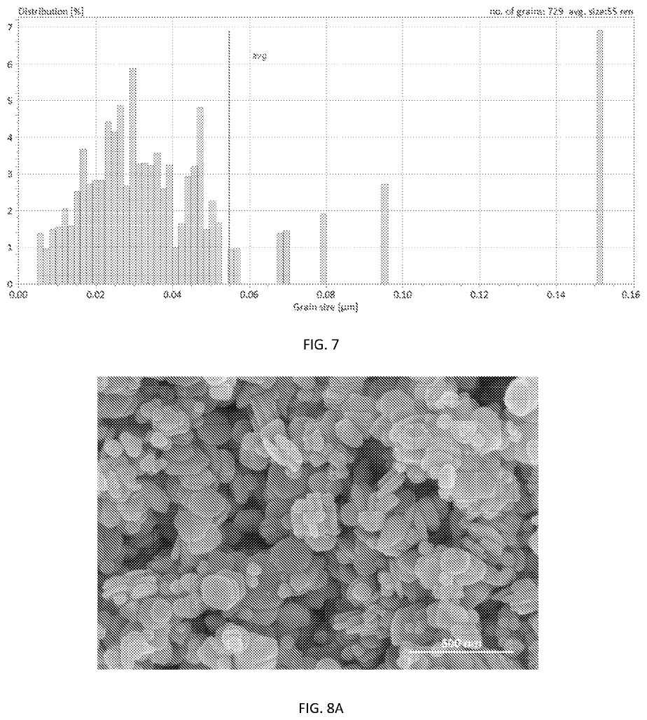

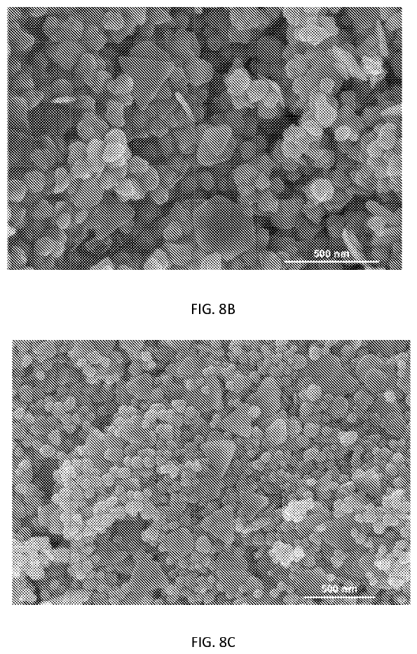

FIG. 7 is a histogram of the particle size distribution obtained from a representative copper nanoparticle synthesis in which platelet nanoparticles are produced. FIGS. 8A-8D are illustrative SEM images of copper nanoparticles produced at various rates of reducing agent introduction. As shown, the platelet nanoparticles may vary considerably in size, and a variable amount of substantially spherical copper nanoparticles may also be present in combination with the platelet nanoparticles. In addition, the platelet nanoparticles may assume a range of semi-regular polygonal shapes. FIG. 8D shows that platelet nanoparticles may readily stack upon one another, even in an as-produced form.

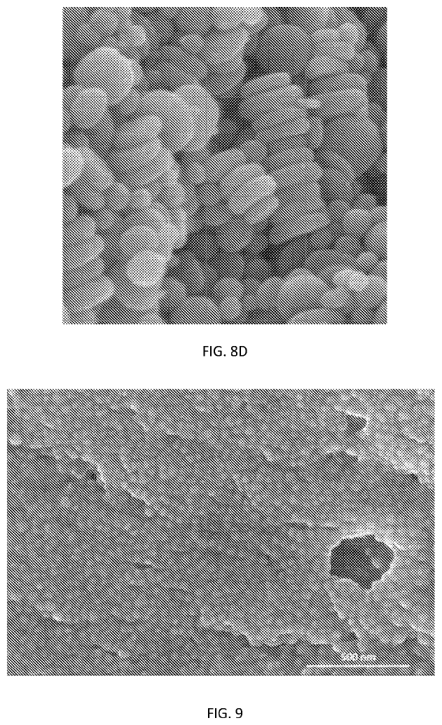

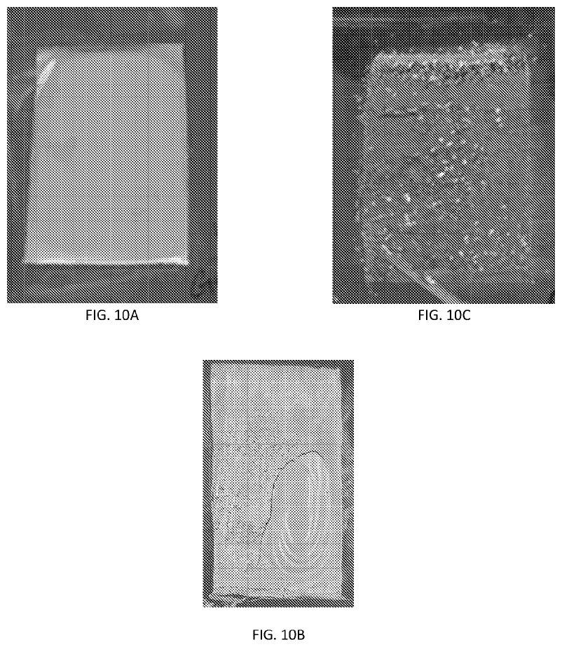

The copper nanoparticles containing platelet nanoparticles were sintered to produce a free-standing film comprising a bulk copper matrix. In brief, reflow (sintering) took place over a period of 4-6 minutes at a peak temperature of 235° C. in a standard commercial convection reflow oven (e.g., by Heller Industries), a BTU reflow oven, a Sikama oven, or the like under an inert gas environment. Comparative copper nanoparticle samples containing primarily substantially spherical metal nanoparticles or a 1:1 mixture of substantially spherical copper nanoparticles and platelet nanoparticles were sintered under the same conditions for comparison. FIG. 9 is an illustrative SEM image of bulk copper formed from predominantly platelet copper nanoparticles following sintering. As shown, there was very little evidence of porosity within the film, indicative of the dense packing afforded by the platelet nanoparticles. FIG. 10A is a photograph of a sintered thin film produced from copper nanoparticles containing predominantly platelet nanoparticles. FIG. 10B is a photograph of a sintered thin film produced from a 1:1 mixture of substantially spherical copper nanoparticles and platelet copper nanoparticles. FIG. 10C is a photograph of a comparative sintered thin film produced from copper nanoparticles containing substantially spherical metal nanoparticles. Each of the sintered thin films was 25 μm in thickness. The sintered thin film produced from predominantly platelet copper nanoparticles (FIG. 10A) was free-standing, light pink in color and appeared to contain a substantially continuous metal layer. The film quality decreased as the loading of substantially spherical copper nanoparticles was increased (FIG. 10B). The comparative sintered thin film produced from substantially spherical copper nanoparticles (FIG. 10C), was duller and more consistent with the bronze color of metallic copper, but considerably more cracked and brittle than was the sintered thin film produced from platelet nanoparticles alone. The comparative thin film contained a plurality of fused copper regions but limited long-range integrity. The electrical resistance of the comparative sintered thin film was about 4 to 30 times higher than that of the sintered thin film produced from copper nanoparticles having predominantly a platelet morphology. Depending on thickness, the sheet resistance values for thin films produced from platelet nanoparticles were about 1-3 mOhm/square and below, whereas when substantially spherical metal nanoparticles were used, the sheet resistance values were in the range of 5-10 mOhm/square and higher.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the features of the present disclosure are presented herein. Not all features of a physical implementation are described or shown in this application for the sake of clarity. It is understood that in the development of a physical embodiment incorporating the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is, therefore evident that the particular illustrative embodiments disclosed above may be altered, combined, or modified and all such variations are considered within the scope and spirit of the present invention. The disclosure herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A composition comprising:
a plurality of copper nanoparticles having a surfactant coating thereon, at least about 20% of the copper nanoparticles being platelet nanoparticles and the surfactant coating comprising at least one surfactant.

2. The composition of claim 1, wherein at least a majority of the copper nanoparticles are platelet nanoparticles.

3. The composition of claim 1, wherein at least about 80% of the copper nanoparticles are platelet nanoparticles.

4. The composition of claim 1, wherein the platelet nanoparticles have a longitudinal thickness ranging from about 5 nm to about 40 nm.

5. The composition of claim 1, wherein the platelet nanoparticles have a longitudinal aspect ratio ranging from about 1 to about 100.

6. The composition of claim 1, wherein the platelet nanoparticles have a largest dimension ranging from about 10 nm to about 400 nm.

7. The composition of claim 1, wherein the plurality of copper nanoparticles further comprises a plurality of substantially spherical copper nanoparticles.

8. (canceled)

9. The composition of claim 1, wherein the at least one surfactant comprises at least one amine surfactant.

10. The composition of claim 9, wherein the at least one amine surfactant comprises two or more amine surfactants.

11. The composition of claim 9, wherein the at least one amine surfactant comprises one or more branched amines.

12. The composition of claim 1, wherein the platelet nanoparticles have a fusion temperature ranging from about 180° C. to about 240° C.

13. A nanoparticle paste comprising the composition of claim 1.

14. (canceled)

15. (canceled)

16. A method comprising:
depositing the composition of claim 1 upon a substrate; and
consolidating the copper nanoparticles to form a bulk copper matrix upon the substrate.

17. The method of claim 16, wherein consolidating the copper nanoparticles comprises heating the composition above a fusion temperature of the copper nanoparticles.

18. The method of claim 16, wherein the platelet nanoparticles have a fusion temperature ranging from about 180° C. to about 240° C.

19. The method of claim 16, wherein the plurality of copper nanoparticles further comprises a plurality of substantially spherical copper nanoparticles.

20. (canceled)

21. The method of claim 16, wherein the at least one surfactant comprises at least one amine surfactant.

22. The method of claim 21, wherein the at least one amine surfactant comprises two or more amine surfactants.

23. The method of claim 21, wherein the at least one amine surfactant comprises one or more branched amines.

24. The method of claim 21, wherein at least a portion of the at least one amine surfactant is removed from the copper nanoparticles below a fusion temperature of the copper nanoparticles when consolidating the copper nanoparticles.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)
